(19) United States
(12) Patent Application Publication
(10) Pub. No.: US 2018/0257752 A1
(43) Pub. Date: Sep. 13, 2018

(54) DYNAMICALLY POSITIONED LIQUID MUD PLANT VESSEL

(71) Applicant: ZENTECH, INC., Houston, TX (US)

(72) Inventors: Joseph SHERWOOD, Weimar, TX (US); Sundaram SRINIVASAN, Sugar Land, TX (US); Ramesh MAINI, Houston, TX (US)

(21) Appl. No.: 15/916,037

(22) Filed: Mar. 8, 2018

Related U.S. Application Data
(60) Provisional application No. 62/468,865, filed on Mar. 8, 2017.

(51) Int. Cl. B63H 25/42; B63H 25/04; B63B 35/44; G05D 1/02

(52) U.S. Cl. CPC B63H 25/42; B63H 25/04; B63B 35/4413; B63B 2747/00; B63B 2213/02; B63H 2025/045; G05D 1/0208

(57) ABSTRACT

The present disclosure generally relates to an apparatus for storing, treating, and making up of various drilling fluids onboard a dynamically positioned vessel, such as a barge, boat, or shop. In particular, the present disclosure relates to a liquid mud plant (LMP) supporting any offshore drilling rig or platform from a vessel in closer proximity to that rig. Additionally, the present disclosure relates to the process by which the liquid mud plant is in closer proximity to the drilling, which is derived from the dynamical positioning capability of the liquid mud plant vessel.

### CROSS-REFERENCE TO RELATED APPLICATIONS

This application claims benefit of U.S. provisional patent application Ser. No. 62/468,865, filed Mar. 8, 2017, which is herein incorporated by reference.

### BACKGROUND

### Field

Embodiments of the present disclosure generally to an apparatus for storing, treating, and making up of various drilling fluids onboard a dynamically positioned vessel, such as a barge, boat, or ship.

### Description of the Related Art

Offshore drilling rigs in search for oil and gas each have their own supply and logistics demands to allow the offshore drilling rigs to work away from the shore. As technology and the need for petroleum advances, more and more of these offshore drilling operations are moving into deep waters (e.g., greater than 500 meters water depth).

Conventionally, a ‘supply base’ is set up as close as feasible to the offshore drilling operation to supply the rig or rigs with necessary daily supplies (e.g., diesel fuel, food, tubulars, drilling fluid, personnel, and the like). As the industry moves further away from the shore (into deeper waters) in pursuit of petroleum, the logistics of supplying a rig with supplies becomes more difficult due the distance between the supply base and the rig. Specifically, the time involved for an Offshore Supply Vessels (OSV), which transports supplies from the supply base to the rig and then back, increases. In deep water operations, the OSV one-way supply time can be in excess of 24 hours depending on the location and weather.

The most often transferred product to a rig, which is often unscheduled due to emergency, is the drilling fluid and chemicals from the supply base liquid mud plant. The drilling fluid and chemicals are used to make up and/or maintain drilling fluid, as well as used in the treatment of mechanical equipment (e.g., drilling waste management centrifuges, dryers, cuttings reinjection, and the like). The drilling operations also produce drill cuttings and solids which can become suspended in the fluids. These “spent” fluids must be treated mechanically and/or chemically in order to remove the contaminants and/or solids in order to achieve the necessary fluid properties for the drilling operations. Additionally, the “cuttings” (i.e., solids removed from wellbore and the spent fluids) are further treated prior to disposal. Drilling fluids can be made up of several base components, such as water, diesel, synthetic oil and/or brine in order to provide a fluid with desired properties. The desired properties, in part, depend on the step of the drilling operation process in which the fluids are used. For example, drilling fluid is used to counter the hydrostatic pressure from the depth of the well during well drilling operations. Heavier drilling fluid is used to a well when this underbalance occurs. Thus, varying types and properties of drilling fluids are often needed during drilling operations.

Therefore, there is a need for a method of and an apparatus for more quickly providing materials to offshore rigs.

### SUMMARY

The present disclosure generally relates to an apparatus for storing, treating, and making up of various drilling fluids onboard a dynamically positioned vessel, such as a barge, boat, or shop. In particular, the present disclosure relates to a liquid mud plant (LMP) supporting any offshore drilling rig or platform from a vessel in closer proximity to that rig. Additionally, the present disclosure relates to the process by which the liquid mud plant is in closer proximity to the drilling, which is derived from the dynamical positioning capability of the liquid mud plant vessel.

In one aspect, a dynamically positioned liquid mud plant vessel comprises a hull; a deck on the hull; a liquid mud plant positioned on the deck; and a plurality of thrusters coupled to the hull, the thrusters rotatable and configured to stabilize the dynamically positioned liquid mud plant vessel in water depths greater than 500 meters.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1A is a schematic side view of a dynamically positioned liquid mud plant vessel (DPLMPV), according to one aspect of the disclosure.

FIG. 1B is a schematic top plan view of the DPLMPV of FIG. 1A.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to an apparatus for storing, treating, and making up of various drilling fluids onboard a dynamically positioned vessel, such as a barge, boat, or shop. In particular, the present disclosure relates to a liquid mud plant (LMP) supporting any offshore drilling rig or platform from a vessel in closer proximity to that rig. Additionally, the present disclosure relates to the process by which the liquid mud plant is in closer proximity to the drilling, which is derived from the dynamical positioning capability of the liquid mud plant vessel.

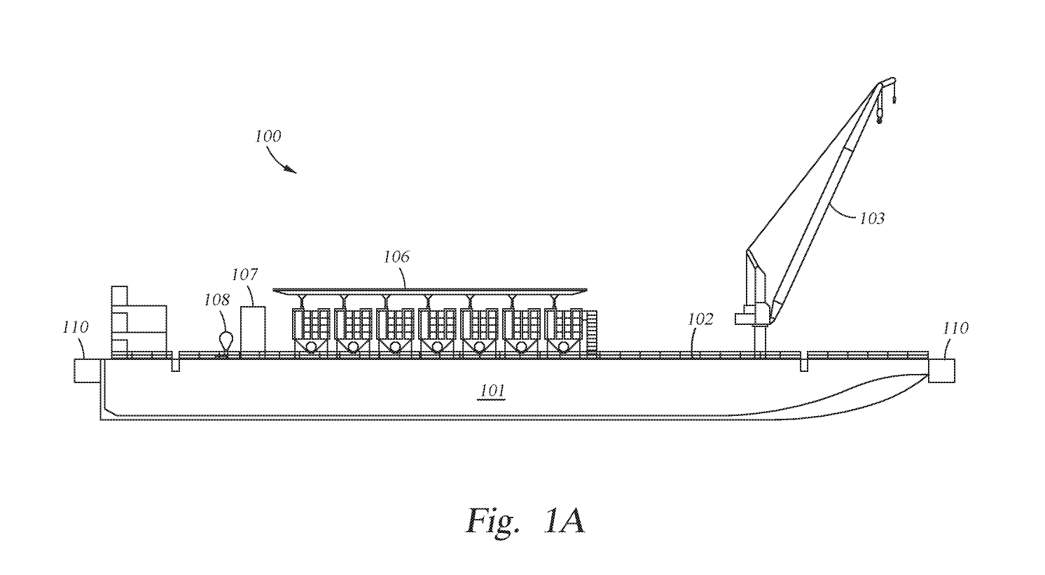

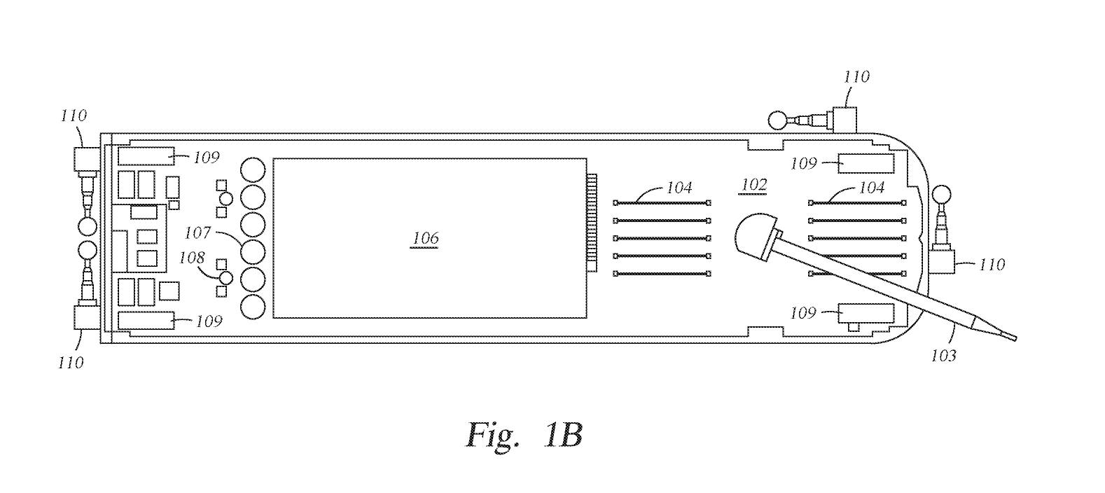

FIG. 1A is a schematic side view of a dynamically positioned liquid mud plant vessel (DPLMPV) 100. FIG. 1B is a schematic top plan view of the DPLMPV 100 of FIG. 1A. The DPLMPV 100 includes a hull 101 having a deck 102. The DPLMPV 100 also includes a crane 103, one or more pipe racks 104 (two sets are shown), and a liquid mud plant 105 positioned on the deck. The liquid mud plant 105 includes one or more pieces of equipment for manufacturing or storing drilling fluid, completions fluid, drilling waste, and hazard drain material, as well as equipment for cleaning tools. It is contemplated that the liquid mud plant 105 may include other equipment as necessary to support the DPLMPV 100. For example, the liquid mud plant 105 can include hoppers, tanks, pumps, centrifuges, dryers, treatment basins, and the like for mechanically and/or chemically separating solids and contaminates from a spent fluid. Further, the liquid mud plan 105 may include equipment such as tanks and blending vessels for combining several base components, such as water, diesel, synthetic oil and/or brine, among others, to manufacture drilling and/or completion fluids. A roof 106 or other structure support is positioned over the liquid mud plant 105 to protect the liquid mud plant 105. The roof 106 may also function as storage space, and materials may be stored on an upper surface thereof.

The DPLMPV 100 also includes one or more bulk tanks skids 107 and surge tanks 108 positioned on the deck 102 aft of the liquid mud plant 105. To facilitate operations on the DPLMPV 100, the DPLMPV 100 also includes one or more power units 109 (four are shown), such as diesel hydraulic power units.

To facilitate positioning of the DPLMPV 100 near a deep water rig, the DPLMPV 100 includes a plurality of thrusters 110 (four are shown). Each thruster 110 is actuatable to provide thrust or drive in a range of about 180 degrees. Thus, each thruster 110 provides stability to the DPLMPV 100 in deep waters, facilitating transfer of drilling mud, fluids, or other chemicals between the DPLMPV 100 and an offshore deep water rig. Conventional shallow water (e.g., water depth less than 500 meters) mobile mud production facilities are unable to provide the requisite level of stability, and therefore, are generally unsatisfactory for deep water applications. However, the inclusion of thrusters 110 provides satisfactory stability for deep water applications.

The thrusters 110 may be provided in a variety of schemes to provide the stability for the DPLMPV 100. For example, the thruster 110 may be powered opposite an opposing thruster 110, thereby maintaining the DPLMPV 100 in position. Additionally or alternatively, the thrusters 110 may be positioned to counteract wind, current, and the like. While the DPLMPV 100 is illustrates has having four thrusters 110, or configurations are also contemplated, such as two to eight thrusters 110. For example, the DPLMPV 100 may include two, six, or eight thrusters 110. In the illustrated example, two thrusters 110 are provided at the stern of the DPLMPV 100, one thruster 110 is provided at the bow of the DPLMPV 100, and one thruster 110 is provided on the port side of the DPLMPV 100. Other configurations are also contemplated, such as one or more thrusters 110 at each the bow and stern, and/or one or more thrusters 110 provide at each the port and starboard sides of the DPLMPV 100.

In one example, the DPLMPV 100 includes a satellite based navigation system, such as a Global Positioning System (GPS). A controller is coupled to the GPS and the thrusters 110 to facilitate operation thereof. Coordinates for a desired position of the DPLMPV 100, such as a position adjacent a deep water rig, may be input into the controller. The controller, in communication with the GPS, can determine the position of the DPLMPV 100 relative to the desired coordinate positions. Then, the controller may actuate (i.e., orient and/or operate) the thrusters 110 to move the DPLMPV 100 as necessary such that the DPLMPV 100 is located at the desired coordinate position. The controller may also continue to monitor the positon of the DPLMPV 100 in relation to the desired coordinate position and adjust the thrusters 110 to maintain the position of the DPLMPV 100. Therefore, the DPLMPV 100 is held in a desired position using the controller and thrusters 110.

In one exemplary use, the DPLMPV 100 is positioned near, or even adjacent to, an oil production platform, such as a drilling platform or production platform. Accordingly, the DPLMPV 100 can rapidly respond to the operational needs of the platform. For example, the DPLMPV 100 can store and treat the drilling fluids and/or well treating fluids used by the platform in operations thereof. The DPLMPV 100 may also store additional supplies, such as fuel, or provide additional crew accommodations for personnel. Therefore, the use of the OSV to deliver needed supplies is greatly reduced. The drilling operations of the platform are thereby increased since the operations are not limited by the delivery of supplies from an OSV. In certain operations, the DPLMPV 100 is connected to the platform by one or more pipelines which facilitate the transfer of fluids and/or cuttings therebetween further reducing the time required to provide supplies to the platform.

In one embodiment, the DPLMPV 100 is a new construction vessel. However, the DPLMPV 100 may also be a barge or other vessel type retrofitted with the thrusters 110 and/or liquid mud plant 105. Moreover, while aspects herein are described with respect to vessels such as ships, it is contemplated that semi-submersibles, drill-ships, jack-ups, and the like, may be configured with mud plants and positioned adjacent deep water drill rigs to also reduce delivery time of supplies, such as drilling mud components, to the offshore drill rig.

Benefits of the disclosure include mitigation of delays in drilling while waiting for deliveries of drilling mud, chemicals, or other fluids via OSVs. In contrast to conventional approaches, the DPLMPV 100 of the present disclosure can be position near a deep water rig, and can produce and/or store drilling mud, fluids and chemicals. Thus, the DPLMPV 100 can much more quickly supply the adjacent deep water rig with consumable materials for drilling operations, rather than waiting for deliveries by an OSV.

While the foregoing is directed to embodiments of the present disclosure, other and further embodiments of the disclosure may be devised without departing from the basic scope thereof, and the scope thereof is determined by the claims that follow.

1. A dynamically positioned liquid mud plant vessel, comprising:
a hull;
a deck on the hull;
a liquid mud plant positioned on the deck; and
a plurality of thrusters coupled with the hull, the thrusters rotatable and configured to stabilize the dynamically positioned liquid mud plant vessel.

2. The vessel of claim 1, wherein the liquid mud plant comprises at least one hopper, tank, pump, centrifuge, dryer, or treatment basin.

3. The vessel of claim 1, wherein the plurality of thrusters comprise a first thruster coupled to the bow, a second thruster coupled to the stern, and a third thruster coupled to the port or starboard side of the hull.

4. The vessel of claim 1, further comprising a controller coupled to the plurality of thrusters.

5. The vessel of claim 4, wherein the controller comprises a satellite positioning system, the controller configured to control the thrusters to maintain the vessel at a desired location.

6. A method of supplying a deep water platform, comprising:
positioning a dynamically positioned liquid mud plant vessel adjacent to a platform, the liquid mud plant vessel having a liquid mud plant thereon; and
providing supplies to the platform from the liquid mud plant vessel.

7. The method of claim 6, wherein the dynamically positioned mud plant vessel comprises a plurality of thrusters.

8. The method of claim 7, further comprising a controller, wherein the controller comprises a satellite positioning system, the controller configured to control the thrusters to maintain the vessel at a desired location.

9. The method of claim 6, wherein the dynamically positioned liquid mud plant comprises at least one hopper, tank, pump, centrifuge, dryer, or treatment basin.

10. The method of claim 6, wherein the dynamically positioned mud plant vessel is coupled to the platform by one or more pipes or hoses.

11. The method of claim 6, wherein the dynamically positioned liquid mud plant vessel treats one or more fluids used by the platform.

12. An offshore facility, comprising:
a vessel;
a platform, wherein the vessel is disposed adjacent to the platform; and
a controller, wherein the controller comprises a satellite positioning system coupled to a plurality of thrusters of the vessel, wherein the vessel is positioned adjacent to the platform by the operations of:
determining a desired coordinate position;
applying the coordinate position to the controller; and
controlling the plurality of thrusters in response to an output from the controller to position the vessel at a location corresponding to the desired coordinate position.

13. The offshore facility of claim 13, wherein the liquid mud plant vessel stores supplies for use by the platform.

14. The offshore facility of claim 13, wherein the vessel comprises a liquid mud plant.

15. The offshore facility of claim 14, wherein the liquid mud plant provides fluids for a drilling operation of the platform.
